(19) United States
(12) Patent Application Publication
(10) Pub. No.: US 2026/0346704 A1
(43) Pub. Date: Nov. 5, 2026

(54) SYSTEM

(71) Applicant: KOMATSU LTD., Tokyo (JP)

(72) Inventors: Yuta Hoshino, Tokyo (JP); Yuuki Ishikawa, Tokyo (JP); Ryousuke Maeda, Tokyo (JP); Masafumi Kuroda, Tokyo (JP); Shuhei Kousaka, Tokyo (JP)

(73) Assignee: KOMATSU LTD., Tokyo (JP)

(21) Appl. No.: 19/123,608

(22) PCT Filed: Sep. 27, 2023
(86) PCT No.: PCT/JP2023/035222

§ 371 Date: Apr. 23, 2025

(30) Foreign Application Priority Data
Nov. 14, 2022 (JP) 2022-181594

(51) Int. Cl. B60K 15/01; B60K 15/03; B60K 15/063; B60L 50/75

(52) U.S. Cl. CPC B60K 15/013; B60K 15/03006; B60K 15/063; B60L 50/75; B60K 2015/03315; B60L 2200/44

(57) ABSTRACT

A system is a system for supplying fuel of a fuel cell to a work vehicle on which the fuel cell is mounted, which includes the work vehicle, a carriage on which the fuel is mounted, and a supply pipe detachably provided between the work vehicle and the carriage and capable of supplying the fuel mounted on the carriage to the work vehicle. The work vehicle is supplied with the fuel mounted on the carriage by the supply pipe while traveling and towing the carriage.

### TECHNICAL FIELD

The present invention relates to a system.

The present invention claims the priority right based on Japanese Patent Application No. 2022-181594 filed on Nov. 14, 2022 in Japan, the content of which is incorporated herein by reference.

### BACKGROUND ART

For carbon neutral, there has been an urgent need for zero emission of mining machines, construction machines, and the like. As one of techniques for achieving zero emission, there has been a fuel cell system. For example, the fuel cell system includes a fuel cell (FC), a battery, and a hydrogen tank that stores hydrogen as fuel. Hydrogen as the fuel has a lower volumetric energy density than those of other types of fuel such as light oil. For example, even if high-pressure hydrogen (about 70 MPa) is stored in the volume of the current light oil tank, the energy thereof is 1/10 or less of that of light oil. That is, when hydrogen is used as the fuel, an operation time is shorter than that when light oil is used as the fuel. In addition, there is also a problem in hydrogen charging. For example, it is difficult for the current technology to charge hydrogen at high speed. For this reason, there is a concern that it takes time to refill hydrogen at a site where the system operates for 24 hours, and therefore the time during which the system can actually operate is reduced.

For example, there are the following two problems when hydrogen is used as the fuel.
(1) It is difficult to mount a great number of hydrogen tanks that store hydrogen having a low volumetric energy density in a limited space.
(2) It takes time to charge hydrogen, and waste (for example, refueling) occurs during the entire operation.

For these reasons, there has been required a system for solving the above-described two problems.

For example, Patent Literature 1 discloses a system including a vehicle and a moving object coupled to the vehicle. The vehicle is equipped with a fuel cell that generates power using hydrogen as fuel, and a hydrogen supply unit that stores hydrogen. The moving object is coupled to the vehicle so as to be towed and capable of exchanging energy. The moving object has a space and equipment used by a person. The moving object includes a heat storage unit and a power storage unit. The heat storage unit recovers heat generated upon power generation of the fuel cell from the vehicle, heats predetermined water with the recovered heat, and stores the heated hot water in a hot water storage tank to store heat. The power storage unit recovers, from the vehicle, surplus power unnecessary for driving the vehicle among power generated upon power generation of the fuel cell, and stores the surplus power in a storage battery. The system accumulates energy generated by the fuel cell and not used for driving the vehicle in the moving object, and uses such energy.

### CITATION LIST

### Patent Literature

PTL 1: JP2003-317787A

### SUMMARY OF INVENTION

### Technical Problem

However, it is difficult to mount a great number of hydrogen supply units that store hydrogen having a low volumetric energy density in a limited space of the vehicle. In addition, it is difficult to fill the hydrogen supply unit mounted on the vehicle with hydrogen at high speed, and it takes time to refill hydrogen. For these reasons, there is room for improvement in solving the above-described two problems.

Therefore, an object of the present invention is to provide a system capable of mounting a great amount of fuel and reducing occurrence of waste during the entire operation.

### Solution to Problem

A system according to one aspect of the present invention is a system for supplying fuel of a fuel cell to a work vehicle on which the fuel cell is mounted, which includes the work vehicle, a carriage on which the fuel is mounted, and a supply pipe detachably provided between the work vehicle and the carriage and capable of supplying the fuel mounted on the carriage to the work vehicle. The work vehicle is supplied with the fuel mounted on the carriage by the supply pipe while traveling and towing the carriage.

### Advantageous Effects of Invention

According to the above-described aspect, it is possible to mount a great amount of fuel and to reduce occurrence of waste over the entire operation.

### BRIEF DESCRIPTION OF DRAWINGS

FIG. 1 is a side view of a system according to an embodiment.

FIG. 2 is a side view when a load is discharged in the system according to the embodiment.

FIG. 3 is a block diagram of the system according to the embodiment.

FIG. 4 is a flowchart showing an example of operation of the system according to the embodiment.

FIG. 5 is a view showing the example of the operation of the system according to the embodiment.

FIG. 6 is a view showing an example of operation of a vehicle according to a comparative example.

### DESCRIPTION OF EMBODIMENTS

Hereinafter, embodiments of the present invention will be described with reference to the drawings. In the embodiments, as an example of a system including a work vehicle, an example where a dump truck which is a transport vehicle that travels at a work site such as a mine and transports a load is applied to the work vehicle will be described.

### System

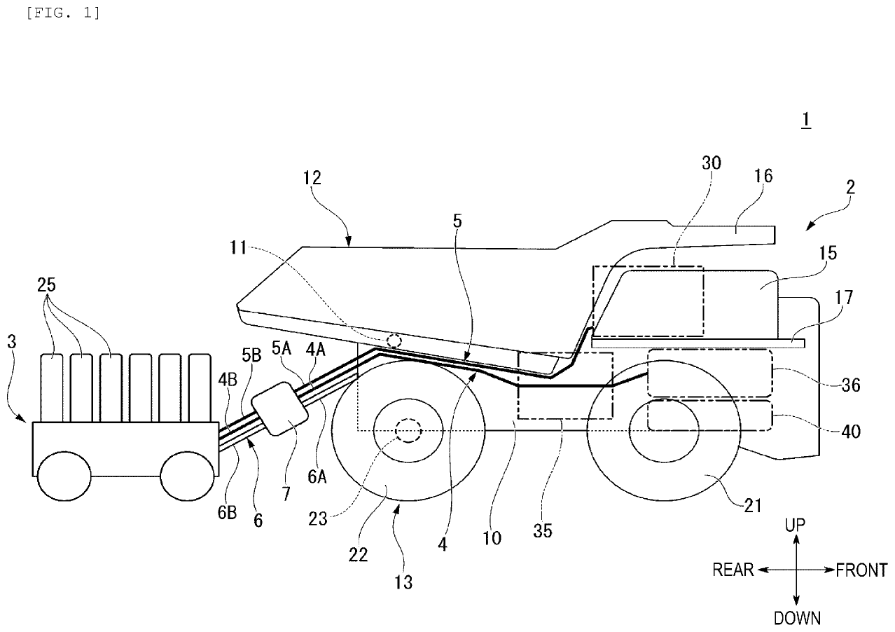

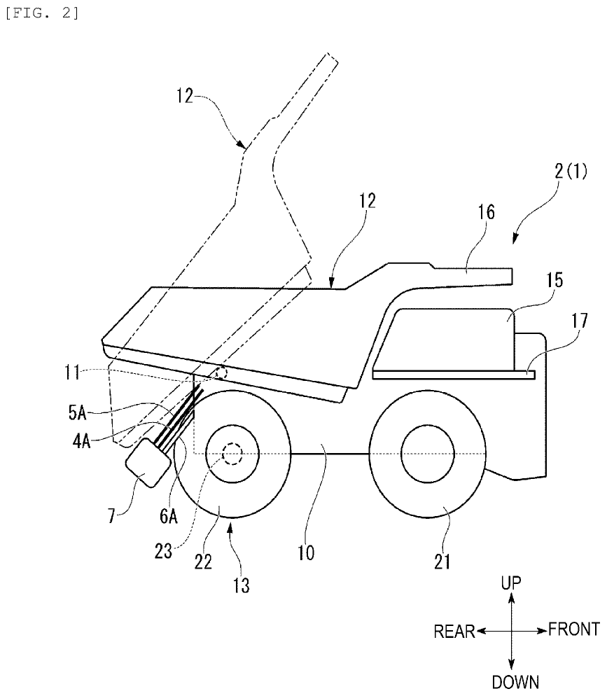

FIG. 1 is a side view of a system 1 according to an embodiment. FIG. 2 is a side view of the system 1 according to the embodiment when a load is discharged.

Referring also to FIGS. 1 and 2, the system 1 includes a dump truck 2, a carriage 3, a supply pipe 4, a harness 5, a traction arm 6, and an attachment/detachment mechanism 7. The system 1 supplies fuel of a fuel cell 36 (hereinafter, also referred to as “FC”) to the dump truck 2 on which the fuel cell 36 is mounted. The dump truck 2 is supplied with fuel loaded on the carriage 3 while traveling and towing the carriage 3.

### Dump Truck

The dump truck 2 includes a vehicle body frame 10 on which the fuel cell 36 is mounted, a dump body 12 (corresponding to a vessel) which is pivotably joined to the vehicle body frame 10 at a pivot portion 11 and on which the load is mounted, and a traveling device 13 having a rear wheel axle 23 supporting rear wheels 22. For example, the dump truck 2 may be an unmanned dump truck to be driven in an unmanned manner without depending on a driving operation by a driver, or may be a manned dump truck to be driven based on a driving operation by a driver.

Hereinafter, the forward direction (vehicle body front), backward direction (vehicle body rear), and vehicle width direction (vehicle body left-right direction) of the dump truck 2 will be referred to as a “vehicle front (one side in the vehicle front-rear direction)”, a “vehicle rear (other side in the vehicle front-rear direction)”, and a “vehicle width direction”. The vehicle width direction may be referred to as a “left side (one side in the vehicle width direction)” or a “right side (other side in the vehicle width direction)”. The right with respect to the direction in which the dump truck 2 moves forward will be referred to as the right side, and the left with respect to the direction in which the dump truck 2 moves forward will be referred to as the left side. The vehicle up-down direction (vehicle body up-down direction), the vehicle upper side (vehicle body upper side) and vehicle lower side (vehicle body lower side) of the dump truck 2 will be simply referred to as an “up-down direction”, “above/upper side”, and “below/lower side”. In the example of the figure, the dump truck 2 is disposed on a horizontal plane (horizontal ground). The vehicle up-down direction (vehicle body up-down direction), vehicle upper side (vehicle body upper side), and vehicle lower side (vehicle body lower side) of the dump truck 2 coincide with an up-down direction (vertical direction), a vertically upper side, and a vertically lower side in a state in which the dump truck 2 is disposed on the horizontal plane, respectively.

The vehicle body frame 10 extends in the vehicle front-rear direction. The vehicle body frame 10 pivotably supports the dump body 12 through the pivot portion 11. The pivot portion 11 is a portion including a shaft portion (corresponding to the pivot center axis of the dump body 12) extending in the vehicle width direction on the vehicle body frame 10. The vehicle body frame 10 is supported by the traveling device 13.

The dump body 12 is pivotably joined to the vehicle body frame 10 at the pivot portion 11. The dump body 12 is a member (corresponding to a truck bed) on which the load is loaded. At least part of the dump body 12 is disposed higher than the vehicle body frame 10. The dump body 12 can perform a dumping operation and a lowering operation.

The dumping operation means an operation of separating the dump body 12 from the vehicle body frame 10 and inclining the dump body 12 in a dumping direction. The dumping direction is rearward of the vehicle body frame 10. In the embodiment, the dumping operation includes lifting a front end portion of the dump body 12 and inclining the dump body 12 rearward. By the dumping operation, the loading surface of the dump body 12 is inclined downward toward the rear side.

The lowering operation means an operation of bringing the dump body 12 close to the vehicle body frame 10. The lowering operation is an operation in a direction opposite to that of the dumping operation. In the embodiment, the lowering operation includes lowering the front end portion of the dump body 12.

The dump body 12 is adjusted to a dump posture and a loading posture by the dumping operation and the lowering operation. The dump posture means a posture in which the dump body 12 is lifted. The loading posture means a posture in which the dump body 12 is lowered. In the example of FIG. 2, the dump body 12 in the loading posture is indicated by a solid line, and the dump body 12 in the dumping posture is indicated by a two-dot chain line.

For example, when performing a discharge work, the dump body 12 performs the dumping operation so as to change from the loading posture to the dump posture. In a case where the load is loaded on the dump body 12, the load is discharged rearward from a rear end portion of the dump body 12 by the dumping operation. When performing a loading work, the dump body 12 is adjusted to the loading posture.

The dump body 12 includes a protector 16 that protects a cab 15 from above. The protector 16 is disposed so as to cover the cab 15 from above when the dump body 12 is in the loading posture. The protector 16 is provided on the front end side of the dump body 12. The protector 16 is disposed higher than the cab 15. The protector 16 extends in the vehicle width direction. For example, the cab 15 is disposed on the vehicle left side with respect to the center in the vehicle width direction.

The cab 15 is supported by a platform 17. The platform 17 is provided to secure a scaffold when an operator gets on and off the cab 15. The platform 17 is provided to secure a scaffold at the time of maintenance of equipment mounted on the dump truck 2. The platform 17 is disposed lower than the protector 16. The platform 17 is disposed higher than wheels 21, 22. The platform 17 extends in the vehicle width direction. The platform 17 is formed in a plate shape parallel to the vehicle front-rear direction and the vehicle width direction.

The traveling device 13 supports the vehicle body frame 10. The traveling device 13 causes the dump truck 2 to travel. The traveling device 13 moves the dump truck 2 forward or backward. At least part of the traveling device 13 is disposed lower than the vehicle body frame 10. The traveling device 13 includes the plurality of wheels 21, 22. The plurality of wheels 21, 22 includes front wheels 21 and rear wheels 22 disposed in rear of the front wheels 21.

The front wheels 21 are wheels to be steered to change the movement direction of the dump truck 2. The left and right front wheels 21 are disposed in pair. The pair of left and right front wheels 21 is disposed with a gap in the vehicle width direction through a front portion of the vehicle body frame 10. One front wheel 21 is provided on each of the left and right sides (two in total).

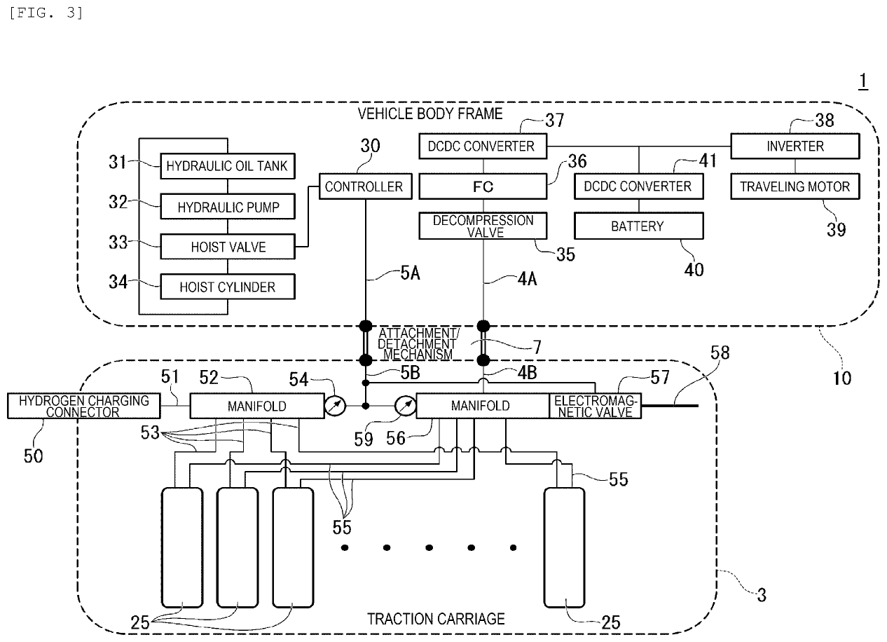

The rear wheels 22 are drive wheels to be driven by a traveling motor 39 (see FIG. 3). The left and right rear wheels 22 are disposed in pair. The pair of left and right rear wheels 22 is disposed with a gap in the vehicle width direction through a rear portion of the vehicle body frame 10. Two rear wheels 22 are provided on each of the left and right sides (four in total).

The rear wheels 22 are supported by the rear wheel axle 23 (corresponding to a rear axle). The rear wheel axle 23 extends in the vehicle width direction so as to support the pair of left and right rear wheels 22. For example, the rear wheel axle 23 is incorporated in a rear axle housing (not shown).

### Carriage

The carriage 3 carries the fuel. The carriage 3 is disposed in rear of the dump truck 2. The carriage 3 is separated from or connected to the dump truck 2 in response to a command from the dump truck 2. For example, in a case where the dump truck 2 is the manned dump truck, the command from the dump truck 2 includes a command based on the driving operation by the driver.

The carriage 3 is configured such that a plurality of cartridge-type hydrogen tanks 25 (an example of a tank) is mountable thereon. The hydrogen tank 25 stores hydrogen as the fuel. In the example of FIG. 1, six hydrogen tanks 25 (an example of the plurality of hydrogen tanks 25) are disposed vertically.

Note that the number and arrangement of the hydrogen tanks 25 are not limited to those described above. For example, the number of hydrogen tanks 25 may be five or less or seven or more. For example, the hydrogen tanks 25 may be disposed horizontally. For example, the number and arrangement of the hydrogen tanks 25 can be changed according to design specifications.

The carriage 3 functions as a hydrogen tank mounting carriage 3 (hereinafter, also simply referred to as a “hydrogen carriage 3”) on which the hydrogen tanks 25 are mounted. The carriage 3 also functions as a hydrogen storage traction carriage 3 (hereinafter, also simply referred to as a “traction carriage 3”) to be towed by the dump truck 2 in a state in which the hydrogen tanks 25 are mounted thereon.

### Supply Pipe

The supply pipe 4 is capable of supplying the fuel mounted on the carriage 3 to the dump truck 2. For example, the supply pipe 4 is formed of a metal pipe. The supply pipe 4 is detachably provided between the dump truck 2 and the carriage 3.

The supply pipe 4 includes a first pipe 4A provided for the dump truck 2 and a second pipe 4B provided for the carriage 3 and detachable from the first pipe 4A. The rear end of the first pipe 4A and the front end of the second pipe 4B are detachably joined to each other by the attachment/detachment mechanism 7.

At least part of the first pipe 4A is disposed higher than the rear wheel axle 23. In a side view, at least part of the first pipe 4A is disposed between the dump body 12 and the rear wheel axle 23. In a side view, the first pipe 4A extends forward from a portion joined to the attachment/detachment mechanism 7 toward the fuel cell 36.

The rear end of the first pipe 4A is disposed forward of the rear end of the dump body 12. For example, when the dump body 12 is in the dump posture, the rear end of the first pipe 4A is preferably disposed in front of the rear end of the dump body 12. According to this configuration, it is possible to reduce a probability of the first pipe 4A becoming an obstacle when the load is discharged (upon dumping from the dump body 12).

### Harness

The harness 5 is capable of transmitting a control signal from a controller 30 mounted on the dump truck 2 to the carriage 3. For example, the harness 5 includes a plurality of electric wires (for example, electric wire bundle). The harness 5 is detachably provided between the dump truck 2 and the carriage 3.

The harness 5 includes a first harness 5A provided for the dump truck 2 and a second harness 5B provided for the carriage 3 and detachable from the first harness 5A. The rear end of the first harness 5A and the front end of the second harness 5B are detachably joined to each other by the attachment/detachment mechanism 7.

At least part of the first harness 5A is disposed above the rear wheel axle 23. In a side view, at least part of the first harness 5A is disposed between the dump body 12 and the rear wheel axle 23. In a side view, the first harness 5A extends forward from a portion joined to the attachment/detachment mechanism 7 toward the controller 30.

The rear end of the first harness 5A is disposed forward of the rear end of the dump body 12. For example, when the dump body 12 is in the dump posture, the rear end of the first harness 5A is preferably disposed in front of the rear end of the dump body 12. According to this configuration, it is possible to reduce a probability of the first harness 5A becoming an obstacle when the load is discharged (upon dumping from the dump body 12).

### Traction Arm

The traction arm 6 is a member for the dump truck 2 to tow the carriage 3. For example, the traction arm 6 is formed of a metal member. The traction arm 6 is detachably provided between the dump truck 2 and the carriage 3.

The traction arm 6 includes a first arm 6A provided for the dump truck 2 and a second arm 6B provided for the carriage 3 and detachable from the first arm 6A. The rear end of the first arm 6A and the front end of the second arm 6B are detachably joined to each other by the attachment/detachment mechanism 7.

At least part of the first arm 6A is disposed above the rear wheel axle 23. In a side view, the first arm 6A extends forward and upward from a portion joined to the attachment/detachment mechanism 7 toward a rear portion of the vehicle body frame 10. For example, the front end of the first arm 6A is pivotably joined to an upper portion of the rear axle housing (not shown).

The rear end of the first arm 6A is disposed forward of the rear end of the dump body 12. For example, when the dump body 12 is in the dump posture, the rear end of the first arm 6A is preferably disposed in front of the rear end of the dump body 12. According to this configuration, it is possible to reduce a probability of the first arm 6A becoming an obstacle when the load is discharged (upon dumping from the dump body 12).

### Attachment/Detachment Mechanism

For example, the attachment/detachment mechanism 7 is a connecting tool such as a quick coupler. The attachment/detachment mechanism 7 is provided in the middle of each of the supply pipe 4, the harness 5, and the traction arm 6. The attachment/detachment mechanism 7 is configured such that the supply pipe 4, the harness 5, and the traction arm 6 are detachable in the middle between the dump truck 2 and the carriage 3. The attachment/detachment mechanism 7 separates or connects the dump truck 2 and the carriage 3 in response to a command from the dump truck 2.

In the example of FIG. 2, the attachment/detachment mechanism 7 is joined to the rear ends of the first pipe 4A, the first harness 5A, and the first arm 6A. The attachment/detachment mechanism 7 is disposed in front of the rear end of the dump body 12. For example, when the dump body 12 is in the dump posture, the entirety of the attachment/detachment mechanism 7 is preferably disposed in front of the rear end of the dump body 12. According to this configuration, it is possible to reduce a probability of the attachment/detachment mechanism 7 becoming an obstacle when the load is discharged (upon dumping from the dump body 12).

FIG. 3 is a block diagram of the system 1 according to the embodiment.

Referring also to FIG. 3, the elements of the system 1 are mounted on the vehicle body frame 10 and the traction carriage 3. Note that in FIG. 3, illustration of the traction arm 6 and the like is omitted.

### Vehicle Body Side System Configuration

The vehicle body frame 10 is equipped with the first harness 5A (hereinafter, also referred to as a “vehicle body side harness 5A”), the controller 30, a hydraulic oil tank 31, a hydraulic pump 32, a hoist valve 33, a hoist cylinder 34, the first pipe 4A (hereinafter, also referred to as a “vehicle body side hydrogen supply pipe 4A”), a decompression valve 35, the fuel cell 36 (FC), an FC DCDC converter 37, an inverter 38, the traveling motor 39, a battery 40, and a battery DCDC converter 41.

One end (end portion opposite to the end portion joined to the attachment/detachment mechanism 7) of the vehicle body side harness 5A is connected to the controller 30. For example, the controller 30 has a processing unit which is a processor such as a CPU, a storage unit such as a RAM, a ROM, or a combination thereof, and an input/output unit. The processing unit controls operations of the elements of the system 1. The storage unit stores a computer program for implementing the function of the processing unit and information necessary for the processing of the processing unit. The input/output unit is an interface circuit between the controller 30 and other devices.

The hydraulic oil tank 31 stores hydraulic oil. The hydraulic oil tank 31 is connected to the hydraulic pump 32. The hydraulic oil discharged from the hydraulic pump 32 is supplied to the hoist cylinder 34 through the hoist valve 33. The hoist valve 33 is electrically connected to the controller 30. The hoist cylinder 34 generates power for performing the dumping operation or the lowering operation of the dump body 12.

One end (end portion opposite to the end portion joined to the attachment/detachment mechanism 7) of the vehicle body side hydrogen supply pipe 4A is connected to the decompression valve 35 for decompressing the fuel. The decompression valve 35 is connected to the fuel cell 36. The decompression valve 35 has a function of releasing a high pressure from the vehicle body side hydrogen supply pipe 4A (primary side) to maintain a pressure on the fuel cell 36 side (secondary side) at a predetermined pressure.

The fuel cell 36 generates power by causing a chemical reaction between hydrogen as fuel gas and oxygen as oxidizing gas. For example, the fuel cell 36 has a stack structure in which a plurality of unit cells is stacked. For example, the fuel cell 36 generates power using oxygen contained in outside air. Note that air containing oxygen may be supplied to the fuel cell 36 by an oxidizing gas supply device (not shown).

The FC DCDC converter 37 adjusts the voltage output from the fuel cell 36. The FC DCDC converter 37 is electrically connected to the fuel cell 36. For example, the FC DCDC converter 37 boosts the voltage generated by the fuel cell 36. The FC DCDC converter 37 supplies the direct current generated by the fuel cell 36 to the inverter 38.

The inverter 38 converts the direct current from the FC DCDC converter 37 into a three-phase alternating current, and supplies the three-phase alternating current to each motor (for example, pump drive motor (not shown) and traveling motor 39). Each of the pump drive motor and the traveling motor 39 is driven based on the three-phase alternating current supplied from the inverter 38.

The pump drive motor drives the hydraulic pump 32. The hydraulic oil discharged from the hydraulic pump 32 is supplied to each of a steering cylinder (not shown) and the hoist cylinder 34. The steering cylinder generates power for steering the front wheels 21. The traveling motor 39 is connected to the rear wheels 22 of the traveling device 13. The rotational force generated by the traveling motor 39 is transmitted to the rear wheels 22 of the traveling device 13.

The battery 40 stores the power generated in the fuel cell 36. As in the fuel cell 36, the battery 40 functions as a power source for the dump truck 2. The battery 40 supplies the stored power to each motor (for example, pump drive motor and traveling motor 39). For example, the battery 40 is a secondary battery such as a lithium ion battery.

For example, the battery 40 drives the traveling motor 39 at the time of starting the dump truck 2 under the control of the controller 30. For example, the battery 40 stores regenerative power during deceleration regeneration of the dump truck 2. For example, the battery 40 is charged with the power supplied from the fuel cell 36 according to the load.

The battery DCDC converter 41 adjusts the voltage output from the battery 40. The battery DCDC converter 41 is electrically connected to the battery 40. For example, the battery DCDC converter 41 boosts the voltage of the battery 40. The battery DCDC converter 41 controls charging and discharging of the battery 40 so that the battery 40 can supply power to the inverter 38 integrally with the fuel cell 36.

For example, in a case where the battery 40 is a main power source for the dump truck 2, the fuel cell 36 may function to charge the battery 40. As a result, the capacity of the fuel cell 36 mounted can be reduced. In addition, by reducing the capacity of the fuel cell 36 mounted, the fuel cell 36 can be easily controlled.

### Carriage Side System Configuration

The traction carriage 3 is equipped with the hydrogen tank 25, a hydrogen charging connector 50, a hydrogen charging upstream pipe 51, a hydrogen charging manifold 52, a hydrogen charging downstream pipe 53, a hydrogen charging pressure sensor 54, a carriage side hydrogen supply upstream pipe 55, a hydrogen supply manifold 56, the second pipe 4B (hereinafter, also referred to as a “carriage side hydrogen supply downstream pipe 4B”), an electromagnetic valve 57, a hydrogen discharge pipe 58, a hydrogen supply pressure sensor 59, and the second harness 5B (hereinafter, also referred to as a “carriage side harness 5B”).

The hydrogen tank 25 stores hydrogen to be supplied to the fuel cell 36. The hydrogen in the hydrogen tank 25 is supplied to the fuel cell 36 through the carriage side hydrogen supply downstream pipe 4B, the vehicle body side hydrogen supply pipe 4A, and the like forming the supply pipe 4. The fuel cell 36 generates power by causing an electrochemical reaction between the hydrogen supplied through the supply pipe 4 and oxygen contained in outside air.

The hydrogen charging connector 50 is connected to the hydrogen charging manifold 52 through the hydrogen charging upstream pipe 51. The hydrogen charging manifold 52 is connected to the hydrogen tank 25 through the hydrogen charging downstream pipe 53. The hydrogen charging manifold 52 has a structure in which one pipe (corresponding to the hydrogen charging upstream pipe 51) is branched into a plurality of pipes (corresponding to a plurality of hydrogen charging downstream pipes 53 corresponding to a plurality of hydrogen tanks 25). The hydrogen tank 25 is filled with the hydrogen through the hydrogen charging connector 50, the hydrogen charging upstream pipe 51, the hydrogen charging manifold 52, and the hydrogen charging downstream pipe 53.

The hydrogen charging pressure sensor 54 is connected to the hydrogen charging manifold 52. The hydrogen charging pressure sensor 54 measures the pressure in the hydrogen charging manifold 52.

The hydrogen tank 25 is connected to the hydrogen supply manifold 56 through the carriage side hydrogen supply upstream pipe 55. The hydrogen supply manifold 56 is connected to the fuel cell 36 through the carriage side hydrogen supply downstream pipe 4B and the like. The hydrogen supply manifold 56 has a structure in which a plurality of pipes (corresponding to a plurality of carriage side hydrogen supply upstream pipes 55 corresponding to the plurality of hydrogen tanks 25) are joined into one pipe (corresponding to the carriage side hydrogen supply downstream pipe 4B). The hydrogen is supplied to the fuel cell 36 through the hydrogen tank 25, the carriage side hydrogen upstream pipe 55, the hydrogen supply manifold 56, the carriage side hydrogen supply downstream pipe 4B, and the like.

The hydrogen discharge pipe 58 is branched from the hydrogen supply manifold 56. The hydrogen discharge pipe 58 is connected to the hydrogen supply manifold 56 through the electromagnetic valve 57. For example, in an emergency, the hydrogen gas in the hydrogen supply manifold 56 may be discharged to the outside through the hydrogen discharge pipe 58.

The hydrogen supply pressure sensor 59 is connected to the hydrogen supply manifold 56. The hydrogen supply pressure sensor 59 measures the pressure in the hydrogen supply manifold 56.

The carriage side harness 5B is electrically connected to the hydrogen charging pressure sensor 54, the hydrogen supply pressure sensor 59, and the electromagnetic valve 57. Detection results (pressure detection signals) of the hydrogen charging pressure sensor 54 and the hydrogen supply pressure sensor 59 are input to the controller 30 through the carriage side harness 5B, the vehicle body side harness 5A, and the like forming the harness 5.

### Arrangement of Elements of System

Referring also to FIG. 1, the fuel cell 36 is disposed in vehicle body front of the decompression valve 35. The battery 40 is disposed lower than the fuel cell 36. The fuel cell 36 and the battery 40 are disposed lower than the platform 17. The controller 30 is disposed higher than the fuel cell 36. The controller 30 is disposed higher than the platform 17.

The fuel cell 36, the battery 40, and the decompression valve 35 are mounted on the vehicle body frame 10. The fuel cell 36, the battery 40, and the decompression valve 35 are preferably disposed within the area of the vehicle body frame 10 in the vehicle width direction. According to this configuration, the fuel cell 36, the battery 40, and the decompression valve 35 are covered with the vehicle body frame 10 from the vehicle body lower side. Thus, it is possible to reduce a probability of disturbance (for example, a flying stone) reaching the fuel cell 36, the battery 40, and the decompression valve 35 from the vehicle body lower side.

### Example of Operation of System

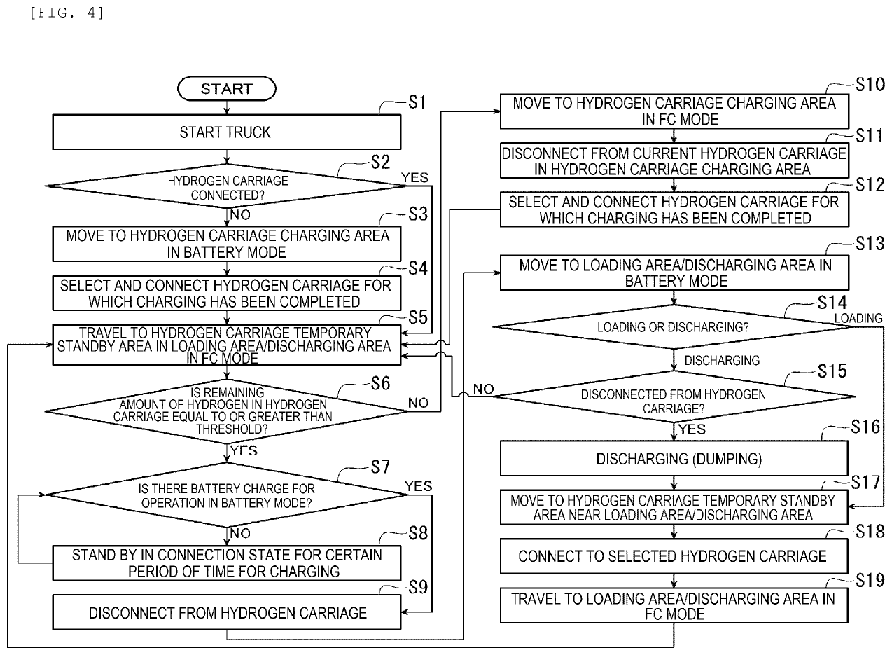

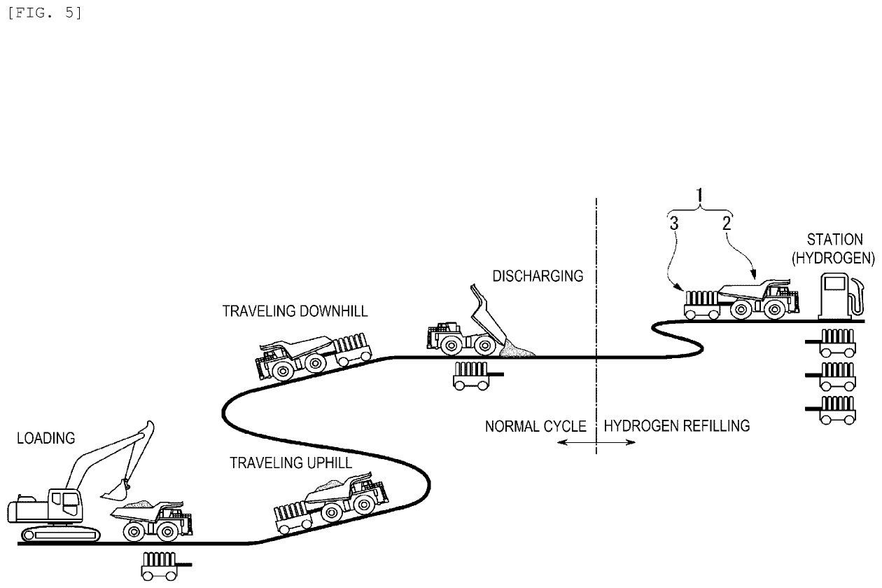

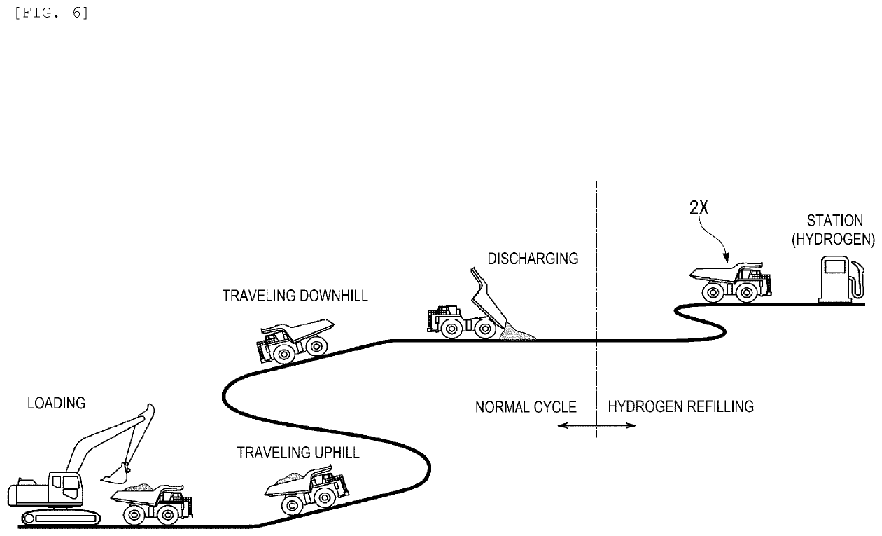

FIG. 4 is a flowchart showing an example of the operation of the system 1 according to the embodiment. FIG. 5 is a view showing the example of the operation of the system 1 according to the embodiment. FIG. 6 is a view showing an example of operation of a vehicle according to a comparative example.

Referring also to FIGS. 4 to 6, in the system 1 according to the embodiment, the dump truck 2 separates the carriage 3 at the time of discharging the load, and travels with the carriage 3 connected thereto after completion of the work of discharging the load.

First, the dump truck 2 is started (Step S1). For example, in Step S1, the battery 40 drives the traveling motor 39 of the dump truck 2 under the control of the controller 30. After Step S1, the process proceeds to Step S2.

In Step S2, the controller 30 determines whether the dump truck 2 is connected to the hydrogen carriage 3. A case where the dump truck 2 is connected to the hydrogen carriage 3 corresponds to a case where the dump truck 2 is connected to the hydrogen carriage 3 through the attachment/detachment mechanism 7 or the like. When the dump truck 2 is connected to the hydrogen carriage 3 (YES in Step S2), the process proceeds to Step S5. On the other hand, when the dump truck 2 is not connected to the hydrogen carriage 3 (NO in Step S2), the process proceeds to Step S3.

In Step S3, the dump truck 2 moves to a hydrogen carriage charging area in a battery mode. The hydrogen carriage charging area is an area for charging the hydrogen carriage 3 or hydrogen (corresponding to a hydrogen charging station). The battery mode is a mode in which the dump truck 2 operates using the battery 40 as a power source. For example, a plurality (three in the example of FIG. 5) of hydrogen carriages 3 for which charging has been completed is provided in the hydrogen carriage charging area (station shown in FIG. 5). For example, since no hydrogen is supplied while the hydrogen carriage 3 is separated, the dump truck 2 travels, loads, or discharges soil only with the battery 40. After Step S3, the process proceeds to Step S4.

In Step S4, the hydrogen carriage 3 for which charging has been completed is selected and connected. For example, in Step S4, the attachment/detachment mechanism 7 connects the dump truck 2 and the hydrogen carriage 3 in response to a command from the dump truck 2. After Step S4, the process proceeds to Step S5.

For example, since the amount of hydrogen loaded on the hydrogen carriage 3 is expected to be large, it usually takes time to charge hydrogen. For example, when a high-pressure gas hydrogen charging rate is 8 to 10 kg/min, it takes about 1 hour to charge 500 kg of hydrogen. In the present embodiment, the plurality of hydrogen carriages 3 for which charging has been completed in advance is provided in the hydrogen carriage charging area. Accordingly, only replacement of the hydrogen carriage 3 is required, and therefore, it does not take time to charge hydrogen.

In Step S5, the dump truck 2 travels in an FC mode to a hydrogen carriage temporary standby area in a loading area/discharging area. The hydrogen carriage temporary standby area is an area provided in the vicinity of the loading area or the discharging area, and is an area for temporarily keeping the hydrogen carriage 3 wait. The FC mode is a mode in which the dump truck 2 operates using the fuel cell 36 (FC) as a power source. For example, since hydrogen is supplied while the hydrogen carriage 3 is connected, the dump truck 2 travels, loads, or discharges soil with the fuel cell 36. For example, when traveling uphill or downhill, the dump truck 2 travels while towing the hydrogen carriage 3. After Step S5, the process proceeds to Step S6.

In Step S6, the controller 30 determines whether the remaining amount of hydrogen in the hydrogen carriage 3 is equal to or greater than a threshold. A case where the remaining amount of hydrogen in the hydrogen carriage 3 is equal to or greater than the threshold corresponds to a case where the dump truck 2 can continue to operate in the FC mode for a predetermined time or more. When the remaining amount of hydrogen in the hydrogen carriage 3 is equal to or greater than the threshold (YES in Step S6), the process proceeds to Step S7. On the other hand, when the remaining amount of hydrogen in the hydrogen carriage 3 is not equal to or greater than the threshold (NO in Step S6), the process proceeds to Step S10.

In Step S10, the dump truck 2 moves to the hydrogen carriage charging area in the FC mode. After Step S10, the process proceeds to Step S11.

In Step S11, the hydrogen carriage 3 and the dump truck 2 currently connected to each other are disconnected from each other in the hydrogen carriage charging area. For example, in Step S11, the attachment/detachment mechanism 7 separates the dump truck 2 and the hydrogen carriage 3 in response to a command from the dump truck 2. After Step S11, the process proceeds to Step S12.

In Step S12, the hydrogen carriage 3 for which charging has been completed is selected and connected. For example, in Step S12, the attachment/detachment mechanism 7 connects the dump truck 2 and the hydrogen carriage 3 in response to a command from the dump truck 2. After Step S12, the process proceeds (returns) to Step S5.

In Step S7, the controller 30 determines whether there is battery charge for operation in the battery mode. A case where there is battery charge for operation in the battery mode corresponds to a case where the battery 40 is charged so that the dump truck 2 can continue to operate in the battery mode for a predetermined time or more. When there is battery charge for operation in the battery mode (YES in Step S7), the process proceeds to Step S9. On the other hand, when there is no battery charge for operation in the battery mode (NO in Step S7), the process proceeds to Step S8.

In Step S8, the process stands by in a connection state for a certain period of time to charge the battery 40. The certain period of time corresponds to a time required for charging the battery 40 to perform the operation in the battery mode. The connection state corresponds to a state in which the dump truck 2 is connected to the hydrogen carriage 3 through the attachment/detachment mechanism 7 or the like. After Step S8, the process proceeds (returns) to Step S7.

In Step S9, the hydrogen carriage 3 and the dump truck 2 connected to each other are disconnected from each other. For example, in Step S9, the attachment/detachment mechanism 7 separates the dump truck 2 and the hydrogen carriage 3 in response to a command from the dump truck 2. After Step S9, the process proceeds to Step S13.

In Step S13, the dump truck 2 moves to the loading area/discharging area in the battery mode. The loading area/discharging area corresponds to a point for performing the work of loading or discharging the load. After Step S13, the process proceeds to Step S14.

In Step S14, the dump truck 2 performs loading or discharging. When the dump truck 2 performs loading (loading in Step S14), the process proceeds to Step S17. On the other hand, when the dump truck 2 performs discharging (discharging in Step S14), the process proceeds to Step S15.

In Step S15, the controller 30 determines whether the hydrogen carriage 3 and the dump truck 2 are disconnected from each other. A case where the hydrogen carriage 3 and the dump truck 2 are disconnected from each other corresponds to a case where the hydrogen carriage 3 is not connected to the dump truck 2 through the attachment/detachment mechanism 7 or the like. When the hydrogen carriage 3 and the dump truck 2 are disconnected from each other (YES in Step S15), the process proceeds to Step S16. On the other hand, when the hydrogen carriage 3 and the dump truck 2 are not disconnected from each other (NO in Step S15), the process proceeds (returns) to Step S5.

In Step S16, the dump truck 2 performs discharging (dumping). In the present embodiment, since the hydrogen carriage 3 is separated from the dump truck 2 in advance, it is possible to reduce a probability of the carriage 3 becoming an obstacle when the load is discharged (upon dumping from the dump body 12). After Step S16, the process proceeds to Step S17.

In Step S17, the dump truck 2 moves to the hydrogen carriage temporary standby area in the vicinity of the loading area/discharging area. After Step S17, the process proceeds to Step S18.

In Step S18, the selected hydrogen carriage 3 and the dump truck 2 are connected. For example, in Step S18, the attachment/detachment mechanism 7 connects the dump truck 2 and the hydrogen carriage 3 in response to a command from the dump truck 2. After Step S18, the process proceeds to Step S19.

In Step S19, the dump truck 2 travels to the loading area/discharging area in the FC mode. After Step S19, the process proceeds (returns) to Step S5.

Referring also to FIGS. 5 and 6, a work vehicle 2X of the comparative example (example of FIG. 6) is a dump truck (corresponding to a normal vehicle) which does not tow the hydrogen carriage 3 of the present embodiment (example of FIG. 5). In the comparative example, a hydrogen tank is mounted on a vehicle body. In the case of the comparative example, since the amount of hydrogen loaded is small, the operation time is likely to be shortened. When the operation time is short, the number of times (frequency) of visits to the station increases, and there is a high probability that it takes time for refueling.

In the present embodiment, since the hydrogen carriage 3 is provided, the amount of hydrogen loaded is greater than that in the comparative example. Therefore, in the present embodiment, the operation time is longer than that of the comparative example. In addition, the number of times (frequency) of visits to the station is reduced. In addition, since it is only necessary to replace the hydrogen carriage 3, the time for refueling is shorter than that of the comparative example.

### Features and Effects

As described above, the system 1 of the present embodiment supplies the fuel of the fuel cell 36 to the dump truck 2 on which the fuel cell 36 is mounted. The system 1 includes the dump truck 2, the carriage 3 on which the fuel is loaded, and the supply pipe 4 which is detachably provided between the dump truck 2 and the carriage 3 and can supply the fuel loaded on the carriage 3 to the dump truck 2. The dump truck 2 is supplied with the fuel mounted on the carriage 3 by the supply pipe 4 while traveling and towing the carriage 3.

According to this configuration, since the carriage 3 on which the fuel is loaded is provided, it is not necessary to load a great amount of fuel in a limited space of the dump truck 2. In addition, since it is only necessary to replace the carriage 3 on which the fuel is loaded at the time of refueling, the time for refueling is short. In addition, since the dump truck 2 is supplied with the fuel mounted on the carriage 3 by the supply pipe 4 while traveling and towing the carriage 3, it is possible to shorten the time required for refueling as much as possible over the entire operation. Therefore, it is possible to mount a great amount of fuel and to reduce occurrence of waste over the entire operation.

In the present embodiment, the supply pipe 4 includes the first pipe 4A provided for the dump truck 2 and the second pipe 4B provided for the carriage 3 and detachable from the first pipe 4A.

According to this configuration, the supply pipe 4 can be attached and detached between the dump truck 2 and the carriage 3 with a simple configuration including the first pipe 4A and the second pipe 4B.

In the present embodiment, the dump truck 2 includes the vehicle body frame 10 on which the fuel cell 36 is mounted, the dump body 12 which is pivotably joined to the vehicle body frame 10 at the pivot portion 11 and on which the load is mounted, and the traveling device 13 having the rear wheel axle 23 supporting the rear wheels 22. The carriage 3 is disposed in rear of the dump truck 2. At least part of the first pipe 4A is disposed higher than the rear wheel axle 23.

According to this configuration, as compared to a case where the entire first pipe 4A is disposed below the rear wheel axle 23, it is possible to reduce a probability of disturbance reaching the first pipe 4A from below the rear wheel axle 23. Therefore, damage to the first pipe 4A can be reduced. For example, it is possible to reduce a probability of the first pipe 4A coming into contact with the ground or a flying stone or the like bounced by the rear wheels 22 colliding with the first pipe 4A.

In the present embodiment, the rear end of the first pipe 4A is disposed forward of the rear end of the dump body 12.

According to this configuration, as compared to a case where the rear end of the first pipe 4A is disposed in rear of the rear end of the dump body 12, it is possible to reduce a probability of the first pipe 4A becoming an obstacle when the load is discharged (upon dumping from the dump body 12).

In the present embodiment, the dump truck 2 separates the carriage 3 at the time of discharging the load, and travels with the carriage 3 connected thereto after completion of the work of discharging the load.

According to this configuration, it is possible to reduce a probability of the carriage 3 becoming an obstacle when the load is discharged (upon dumping from the dump body 12). In addition, after completion of the work, the dump truck 2 can travel while being supplied with the fuel mounted on the carriage 3.

In the present embodiment, the carriage 3 is separated from or connected to the dump truck 2 in response to a command from the dump truck 2.

According to this configuration, it is not necessary to manually separate or connect the dump truck 2. This contributes to automation of the system 1. For example, the supply pipe 4 can be automatically attached and detached.

In the present embodiment, the carriage 3 is configured such that the plurality of cartridge-type hydrogen tanks 25 is mountable thereon.

According to this configuration, as compared to a case where the carriage 3 is configured such that only one huge tank is mountable thereon, a greater number of hydrogen tanks 25 can be mounted on the carriage 3, and the hydrogen tank 25 can be easily replaced.

### Modifications

In the above-described embodiment, the example where the supply pipe includes the first pipe provided for the work vehicle and the second pipe provided for the carriage and detachable from the first pipe has been described, but the present invention is not limited thereto. For example, the supply pipe does not necessarily include the first pipe and the second pipe. For example, the supply pipe may be provided for one of the work vehicle or the carriage, and may be detachable from the other one of the work vehicle or the carriage. For example, the configuration of the supply pipe can be changed according to design specifications.

In the above-described embodiment, the example where the work vehicle is the dump truck has been described, but the present invention is not limited thereto. For example, the work vehicle may be another work vehicle such as a shovel, a bulldozer, or a wheel loader. For example, the form of the work vehicle can be changed according to design specifications.

In the above-described embodiment, the example where the carriage is disposed in rear of the dump truck has been described, but the present invention is not limited thereto. For example, the carriage may be disposed in front of or beside the dump truck. For example, the arrangement of the carriage can be changed according to design specifications.

In the above-described embodiment, the example where at least part of the first pipe is disposed above the rear wheel axle has been described, but the present invention is not limited thereto. For example, the entire first pipe may be disposed below the rear wheel axle. For example, the arrangement of the first pipe can be changed according to design specifications.

In the above-described embodiment, the example where the rear end of the first pipe is disposed in front of the rear end of the dump body has been described, but the present invention is not limited thereto. For example, the rear end of the first pipe may be disposed in rear of the rear end of the dump body. For example, the arrangement of the rear end of the first pipe can be changed according to design specifications.

In the above-described embodiment, the example where the dump truck separates the carriage at the time of discharging the load has been described, but the present invention is not limited thereto. For example, the dump truck may separate the carriage when loading the load. For example, the dump truck may be kept connected to the carriage when the load is discharged or loaded. For example, the timing of separating the carriage can be changed according to design specifications.

In the above-described embodiment, the example where the carriage is separated from or connected to the dump truck in response to the command from the dump truck has been described, but the present invention is not limited thereto. For example, separation from or connection to the dump truck may be performed manually. For example, the supply pipe may be manually attached and detached. For example, the method for separation from or connection to the dump truck can be changed according to design specifications.

In the above-described embodiment, the example where the carriage is configured such that the plurality of cartridge-type hydrogen tanks is mountable thereon has been described, but the present invention is not limited thereto. For example, the carriage may be configured such that only one huge tank is mountable thereon. For example, the form of the hydrogen tank mounted on the carriage can be changed according to design specifications.

In the above-described embodiment, the example where the tank mounted on the carriage is the hydrogen tank that stores hydrogen as the fuel has been described, but the present invention is not limited thereto. For example, the tank mounted on the carriage may include one that stores fuel (for example, hydraulic oil) other than hydrogen. For example, the form of the fuel stored in the tank can be changed according to design specifications.

In the above-described embodiment, the example where the traction arm is provided separately from the supply pipe has been described, but the present invention is not limited thereto. For example, the supply pipe may also serve as a traction arm for towing the carriage. For example, the supply pipe may pass through the inside of the traction arm. For example, a fuel supply path may be provided inside the traction arm.

According to this configuration, since the supply pipe also serves as the traction arm for towing the carriage, it is not necessary to provide the traction arm separately from the supply pipe. Therefore, the number of components can be reduced.

While the embodiments of the present invention have been described above, the present invention is not limited thereto, and additions, omissions, substitutions, and other changes of the configurations can be made without departing from the spirit of the present invention, and the above-described embodiments can be combined as appropriate.

### Appendix 1

A system for supplying fuel of a fuel cell to a work vehicle on which the fuel cell is mounted, which includes
the work vehicle,
a carriage on which the fuel is mounted, and
a supply pipe detachably provided between the work vehicle and the carriage and capable of supplying the fuel mounted on the carriage to the work vehicle,
the work vehicle being supplied with the fuel mounted on the carriage by the supply pipe while traveling and towing the carriage.

### Appendix 2

The system according to Appendix 1, in which
the supply pipe includes
a first pipe provided for the work vehicle, and
a second pipe provided for the carriage and detachable from the first pipe.

### Appendix 3

The system according to Appendix 2, in which
the work vehicle is a dump truck,
the dump truck includes
a vehicle body frame on which the fuel cell is mounted,
a dump body which is pivotably joined to the vehicle body frame at a pivot portion and on which a load is mounted, and
a traveling device having a rear wheel axle supporting a rear wheel,
the carriage is disposed in rear of the dump truck, and at least part of the first pipe is disposed above the rear wheel axle.

### Appendix 4

The system according to Appendix 3, in which
the rear end of the first pipe is disposed forward of the rear end of the dump body.

### Appendix 5

The system according to any one of Appendixes 1 to 4, in which
the supply pipe also serves as a traction arm for towing the carriage.

### Appendix 6

The system according to any one of Appendixes 3 to 5, in which
the dump truck
separates the carriage when the load is discharged or loaded, and
travels with the carriage connected thereto after completion of a work of discharging or loading the load.

### Appendix 7

The system according to any one of Appendixes 1 to 6, in which
the carriage is separated from or connected to the work vehicle in response to a command from the work vehicle.

### Appendix 8

The system according to any one of Appendixes 1 to 7, in which
the carriage is configured such that a plurality of cartridge-type tanks is mountable thereon.

### REFERENCE SIGNS LIST

1 System
2 Dump truck (Work vehicle)
3 Carriage
4 Supply pipe
4A Vehicle body side hydrogen supply pipe (First pipe)
4B Carriage side hydrogen supply downstream pipe (Second pipe)
6 Traction arm
10 Vehicle body frame
11 Pivot portion
12 Dump body
13 Traveling device
22 Rear wheel
23 Rear wheel axle
25 Hydrogen tank (Tank)
36 Fuel cell

1. A system for supplying fuel of a fuel cell to a work vehicle on which the fuel cell is mounted, comprising:
the work vehicle;
a carriage on which the fuel is mounted; and
a supply pipe detachably provided between the work vehicle and the carriage and capable of supplying the fuel mounted on the carriage to the work vehicle,
wherein the work vehicle is supplied with the fuel mounted on the carriage by the supply pipe while traveling and towing the carriage.

2. The system according to claim 1, wherein
the supply pipe includes
a first pipe provided for the work vehicle, and
a second pipe provided for the carriage and detachable from the first pipe.

3. The system according to claim 2, wherein
the work vehicle is a dump truck,
the dump truck includes
a vehicle body frame on which the fuel cell is mounted,
a dump body which is pivotably joined to the vehicle body frame at a pivot portion and on which a load is mounted, and
a traveling device having a rear wheel axle supporting a rear wheel,
the carriage is disposed in rear of the dump truck, and
at least part of the first pipe is disposed above the rear wheel axle.

4. The system according to claim 3, wherein
a rear end of the first pipe is disposed forward of a rear end of the dump body.

5. The system according to claim 1, wherein
the supply pipe also serves as a traction arm for towing the carriage.

6. The system according to claim 3, wherein
the dump truck
separates the carriage when the load is discharged or loaded, and
travels with the carriage connected thereto after completion of a work of discharging or loading the load.

7. The system according to claim 1, wherein
the carriage is separated from or connected to the work vehicle in response to a command from the work vehicle.

8. The system according to claim 1, wherein
the carriage is configured such that a plurality of cartridge-type tanks is mountable thereon.

9. The system according to claim 2, wherein
the supply pipe also serves as a traction arm for towing the carriage.

10. The system according to claim 2, wherein
the carriage is separated from or connected to the work vehicle in response to a command from the work vehicle.

11. The system according to claim 2, wherein
the carriage is configured such that a plurality of cartridge-type tanks is mountable thereon.
